(19) United States
(12) Patent Application Publication
(10) Pub. No.: US 2023/0139089 A1
(43) Pub. Date: May 4, 2023

(54) METHOD FOR OPTIMIZING FIREWALL POLICIES AND APPARATUS THEREOF

(71) Applicant: SAMSUNG SDS CO., LTD., Seoul (KR)

(72) Inventors: Jae Young PARK, Seoul (KR); Sang Woo Kang, Seoul (KR)

(73) Assignee: Samsung SDS Co., Ltd., Seoul (KR)

(21) Appl. No.: 17/976,374

(22) Filed: Oct. 28, 2022

(30) Foreign Application Priority Data
Oct. 29, 2021 (KR) 10-20210147153

(51) Int. Cl. H04L 9/40

(52) U.S. Cl. CPC H04L 63/0263; H04L 63/20; H04L 63/1425; H04L 63/0236

(57) ABSTRACT

A method of optimizing firewall policies according to some embodiments of the present disclosure includes obtaining a traffic log of network traffic passing through a firewall subject to a policy set including a plurality of firewall policies, generating training data by using the traffic log, clustering the training data, generating a rule set including a plurality of rules by using a result of the clustering, generating candidate unit policies by using the rule set, calculating a coverage score indicating a degree to which the candidate unit policies cover firewall policies of the policy set, and repeating the generating of the candidate unit policies and the calculating of the coverage score until the coverage score satisfies a criterion.

### CROSS-REFERENCE TO RELATED APPLICATION

This application claims priority from Korean Patent Application No. 10-2021-0147153 filed on Oct. 29, 2021 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method of optimizing firewall policies and an apparatus therefor. More particularly, the present disclosure relates to a method of optimizing firewall policies and an apparatus therefor, which resolve issues of firewall systems over time since the beginning of their operation in such burdensome aspect as an excessive increase in the number of firewall policies.

### 2. Description of the Related Art

Defined as a system to monitor and control traffic in a network, a firewall is a basic network security system for allowing access of an accessible trusted host or network, while blocking access of untrusted traffic. In general, the network administrator registers the access permission policy requested by the user with the firewall system which then controls access to the network according to the registered allow/block policies.

With accumulating policies registered in the firewall system as time passes, policies increasingly become troublesome in network security in the form of unused policies and unnecessary policies. This requires verification or optimization of the firewall policies registered with the firewall system.

There is a technology disclosed about optimizing firewall policies using a network log. For example, U.S. Pat. No. 9,894,100 and U.S. Pat. No. 10,148,620 disclose extracting information from a traffic log to provide an administrator with an informing report, thereby helping the administrator to assign a new firewall policy, or rendering a new traffic log when inputted to activate checking of its dependency with the existing policy set and to optimize the updated policy set. This technology may well reflect a new policy in the optimization process, while the existing firewall policies remain untouched and thus continue to pose their existential trouble unsolved.

Most networks where access rights are managed will see a steady increase in the number of unused firewall policy sets or unused firewall policies over time. This issues various difficulties to occur, such as a management burden and a security loophole in the network. To solve the issues, the network administrator could take operational measures based on human judgment, such as blocking unnecessary applications as much as possible from members about firewall policy registration and setting an effective period for each firewall policy to delete the expired firewall policy. Notwithstanding these measures, no fundamental prevention is available against the anomalous accumulation of unwanted policies including those unused.

### SUMMARY

Aspects of the present disclosure provide a method of optimizing firewall policies and an apparatus therefor, which, generate an optimized firewall rule based on a traffic log of network traffic passed by the firewall system.

Another aspect of the present disclosure provides a method of optimizing firewall policies and an apparatus therefor, which generate an optimized firewall rule regardless of the existing firewall policies but based on a traffic log of firewall-passing network traffic resulting from the operation of the existing firewall policies.

Yet another aspect of the present disclosure provides a method of optimizing firewall policies and an apparatus therefor, which increase in the requisite time for firewall policy generation according to an increase in the size of network traffic passing through the firewall is not large.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some embodiments of the present disclosure, there is provided a method performed by a computing device for optimizing firewall policies. The method comprises obtaining a traffic log of network traffic passing through a firewall subject to a policy set comprising a plurality of firewall policies, generating training data by using the traffic log, clustering the training data, generating a rule set comprising a plurality of rules by using a result of the clustering, generating candidate unit policies by using the rule set, calculating a coverage score indicating a degree to which the candidate unit policies cover firewall policies of the policy set, and repeating the generating of the candidate unit policies and the calculating of the coverage score until the coverage score satisfies a criterion.

According to another embodiments of the present disclosure, there is provided an apparatus for optimizing firewall policies. The apparatus comprises a network interface connected to a firewall system, memory, and a processor for executing a firewall policy optimization program loaded into the memory, wherein the firewall policy optimization program comprises instructions to performs operations of obtaining a traffic log of network traffic passing through a firewall subj ect to a policy set comprising a plurality of firewall policies, generating training data by using the traffic log, clustering the training data, generating a rule set comprising a plurality of rules by using a result of the clustering, generating candidate unit policies by using the rule set, calculating a coverage score indicating a degree to which the candidate unit policies cover firewall policies of the policy set, and repeating, until the coverage score satisfies a criterion, the clustering of the training data, the generating of the rule set, the generating of the candidate unit policies, and the calculating of the coverage.

According to another embodiments of the present disclosure, there is provided a computer-readable medium storing a computer program including computer-executable instructions for causing, when executed in a computing device, the computing device to perform operations including obtaining a traffic log of network traffic passing through a firewall subject to a policy set comprising a plurality of firewall policies, generating training data by using the traffic log, clustering the training data, generating a rule set comprising a plurality of rules by using a result of the clustering, generating candidate unit policies by using the rule set, calculating a coverage score indicating a degree to which the candidate unit policies cover firewall policies of the policy set, and repeating the generating of the candidate unit policies and the calculating of the coverage score until the coverage score satisfies a criterion.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram for explaining the operation of a system including a firewall policy optimizing apparatus according to at least one embodiment of the present disclosure.

FIG. 2 is a flowchart of a firewall policy optimizing method according to another embodiment of the present disclosure.

FIGS. 3A and 3B are diagrams of an illustrative traffic log and training data based on the traffic log.

FIG. 4 is a diagram of example firewall policy application information.

FIG. 5 is a diagram illustrating a result of the normalization of the example firewall policy information.

FIG. 6 is a diagram for explaining a method of determining whether optimization is required for a firewall policy.

FIG. 7 is a diagram of an example rule pool.

FIG. 8 is a diagram illustrating a case of merging candidate unit policies according to some embodiments of the present disclosure.

FIG. 9 is a diagram of a hardware configuration of a computing device that may be used as a component in some embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof

Hereinafter, some embodiments will be described with reference to the accompanying drawings.

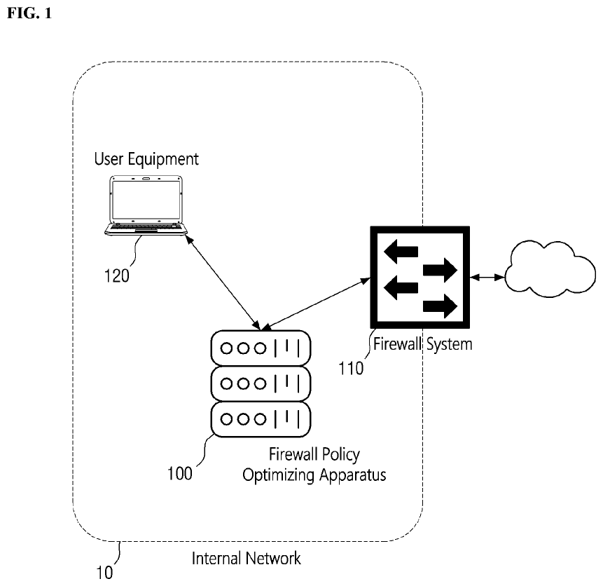

Referring to FIG.1, the following describes a configuration and operation of a system including a firewall policy optimizing apparatus 100 according to at least one embodiment of the present disclosure.

The firewall system 110 controls the devices included in an internal network 10 to transmit and receive packets to and from an external network. The firewall system 110 may filter packet transmission/reception with the external network by using a plurality of firewall policies. For example, conditions may be defined to allow packet transmission and reception with the external network, and the conditions may each be understood as each of the firewall policies.

The firewall policy optimizing apparatus 100 may be located inside the internal network 10, as shown in FIG. 1, to receive, from the firewall system 110, a network traffic log that has passed through the firewall system 110. The network traffic log may include at least some outbound traffic from the internal network 10 to the external network and inbound traffic from the external network to the internal network 10. Different from the illustration of FIG. 1, some embodiments may well place the firewall policy optimizing apparatus 100 outside the internal network 10.

The firewall policy optimizing apparatus 100 may operate under the control of user equipment 120 or according to its schedule to generate one or more optimized firewall policies by analyzing the network traffic log. The user equipment 120 may be understood as a terminal used by a network administrator of the internal network 10. Additionally, the firewall policy optimizing apparatus 100 may transmit report data on the optimized firewall policies generated to the user equipment 120.

The report data may include comparison information between the optimized firewall policies and one or more currently applied firewall policies in the firewall system 110. For example, the comparison information may include at least some information on a comparison of the number of firewall policies between the optimized firewall policies and the currently applied firewall policies in the firewall system 110, information on coverage scores of the optimized firewall policies over the existing firewall policies, and analysis information on packets dropped (or missed) by observing the optimized firewall policies compared to the existing firewall policies.

Additionally, the firewall policy optimizing apparatus 100 may analyze the network traffic log to generate evaluation data on whether there is a need for an optimization of the existing firewall policy, and transmit the evaluation data to the user equipment 120. Additionally, in some embodiments, the firewall policy optimizing apparatus 100 may be responsive when the requisite score for optimization according to the evaluation data exceeds a reference value for automatically performing a firewall policy optimization process.

The firewall policy optimization process may include composing training data by using the traffic log, clustering the training data, generating a rule set composed of a plurality of rules by using a result of the clustering, generating candidate unit policies by using the rule set, calculating a coverage score for a degree to which the candidate unit policies cover firewall policies of the existing policy set, and repeating the generating of the candidate unit policies and the calculating of the coverage score until the coverage score satisfies a reference or criterion.

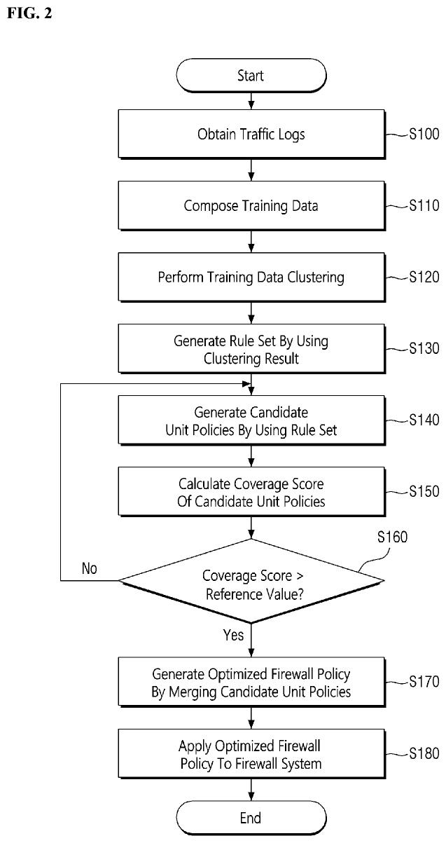

A more detailed operation of the firewall policy optimizing apparatus 100 will be described below in detail with reference to FIGS. 2 to 8.

The following describes a firewall policy optimizing method according to another embodiment of the present disclosure with reference to FIGS. 2 to 8. The firewall policy optimizing method according to the present embodiment may be performed by one or more computing devices. For example, in the firewall policy optimizing method according to the present embodiment, all operations may be performed by a single computing device, or some of the operations may be performed by another computing device. Hereinafter, in describing the method according to the present embodiment, descriptions of subjects performing some operations may be omitted. In this case, it should be understood that the subject performing the relevant operation is the computing device. The computing device may be, for example, the firewall policy optimizing apparatus 100 in the embodiment described with reference to FIG. 1, but the computing device is not limited in any way to the firewall policy optimizing apparatus 110. For example, the computing device may be the firewall system 110 described with reference to FIG. 1.

In Step S100, the firewall policy optimizing method obtains a traffic log of network traffic passing through a firewall subject to an existing policy set including a plurality of firewall policies. The traffic log may be received from the firewall system or may be obtained as a result of network monitoring of the firewall system.

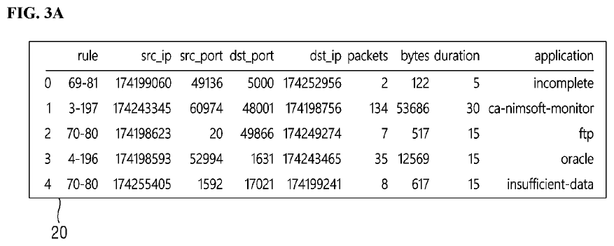

In Step S110, the traffic log is utilized to generate training data. For example, the traffic log may be data 20 shown in FIG. 3A. As shown in FIG. 3A, the traffic log 20 includes only basic information such as a sender or source IP (i.e., IP address), a source port (i.e., port number), a destination IP, and a destination port for each of the records. It is noted that in the traffic log 20 shown in FIG. 3A, the IP address is displayed as an integer. For example, the first record of the traffic log 20 includes data of packets passed by firewall policies 69 to 81, in particular, information on their source IP, source port, destination IP, and destination port, and information on the number of packets, the size of packets, etc.

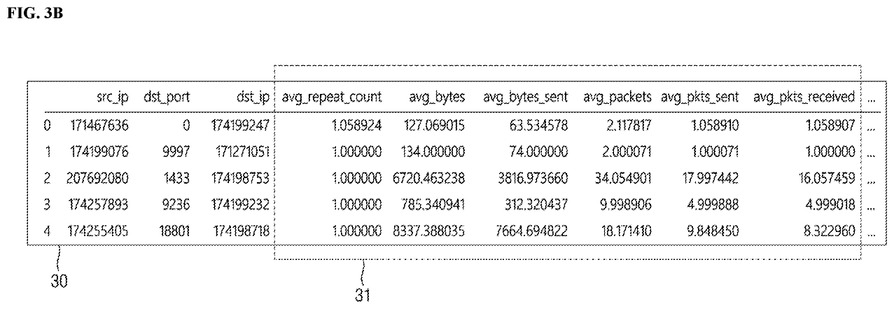

Meanwhile, some embodiments may determine the need for optimizing the firewall policies through analysis of the existing firewall policies. The outcome may help to determine whether to proceed with the subsequent firewall policy optimization process, which will be discussed now with reference to FIGS. 4 to 6.

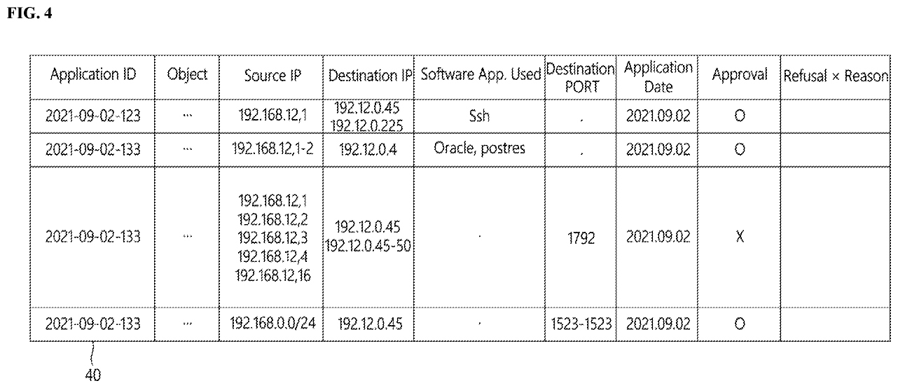

FIG. 4 shows firewall policy application information 40 which is exemplary. The firewall policy application information 40 includes firewall policy applications inputted respectively according to a defined format. The firewall policy application information 40 is not suitable for automated processing for, among other reasons, including a plurality of IPs in one application. Therefore, the firewall policy optimizing method may correct the firewall policy application information 40 through an analysis process into a suitable form for automated processing. The correction may be to decompose each of the firewall policies into one source IP, one destination IP, and one destination port. FIG. 5 shows the corrected firewall policy application information 41. Some embodiments extract, from the traffic log, information on the number of packets corresponding to each record of the corrected firewall policy application information 41 and thereby calculate the requisite score for optimization, indicating whether the firewall policy optimization process needs to be performed. For example, the requisite score for optimization may be calculated so that the more the uniformity of the number of packets for each record, the lower the requisite score for optimization.

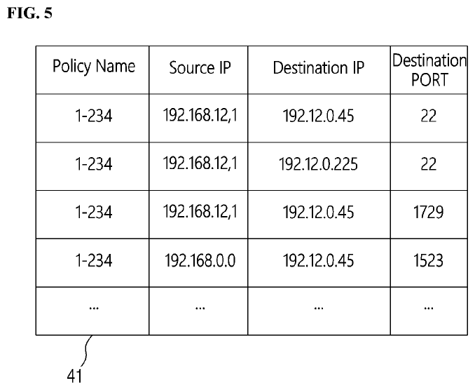

Some embodiments may use the destination ports of firewall-passing packets included in the traffic log as a basis for calculating the distribution of the packet frequencies by port range. FIG. 6 shows an interval tree 50 generated by using the destination ports of the firewall-passing packet included in the traffic log. Port numbers ‘22 to 3000’ are the overall distribution with each node in the interval tree indicating the packet frequency for each node by a number in a box. Referring to the interval tree 50 of FIG. 6, it can be seen that almost no packets are generated in the port range ‘1450 to 1500’.

As an example, when a node of the interval tree 50 sees the generation of a packet frequency less than a reference value, the requisite score for optimization may be so calculated to have a higher value. Additionally, in another example, the requisite score for optimization may be calculated so that the more the uniformity of the packet frequency for each node in the interval tree 50, the lower the requisite score for optimization.

In some embodiments, the firewall policy optimizing method may be responsive when the requisite score for optimization exceeds a reference value for transmitting a message to the user equipment of the administrator asking whether to perform the firewall policy optimization process. Upon receiving a control signal to perform the firewall policy optimization process from the user equipment of the administrator in response to this message, the firewall policy optimizing method will perform the firewall policy optimization process to be described below.

To generate an optimized firewall policy, the amount of information included in the traffic log needs to be increased. Accordingly, as shown in FIG. 3B, statistical data may be generated for the information included in the traffic log, and the statistical data may be added to the traffic log. That is, in some embodiments, the training data may be generated by adding the statistical data to original data for some items (e.g., at least one item) of the traffic log. FIG. 3B shows training data 30 obtained with statistical data 31 added to the existing traffic log. The statistical data may include statistical values such as an average of repeated transmission times of packets, an average packet size, an average transmitted packet size, and an average number of packets. The statistical data may be generated for some items of the traffic log. Some of the items refer to preset core attributes such as destination IP address and destination port.

In Step S120, clustering may be performed by using the training data 30. The clustering will result in the formation of a plurality of clusters in which the respective firewall-passing packets are clustered.

In some embodiments, the clustering may be performed in a parallel manner by dividing the clustering into a first clustering and a second clustering to avoid the omission of a cluster of packets to be considered in generating a firewall policy. The first clustering may be performed by using some items of the traffic log, and the second clustering may be performed by using at least some of the statistical data. In particular, the first clustering performs the clustering based on the core attributes of the packet, and the second clustering performs the clustering in consideration of the increased information included in statistical data, to provide the effect of the additional discovery of clusters missing from the first clustering process. Therefore, the second clustering may be understood as performing clustering in a multidimensional feature space.

In some embodiments, the first clustering may be port-based clustering performed based on a destination port which is a key attribute defining characteristics of the traffic log. The first clustering will result in the formation of a plurality of clusters, of which one or more main clusters are selected for exceeding a reference value. The main cluster may be selected, for example, depending on whether the total number of packets included in the cluster exceeds a first reference value.

Meanwhile, in some embodiments, before performing the first clustering, the training data may be cleared of data of a preset general-purpose port and a preset special-purpose port among data included in the traffic log. The preset general-purpose port may include, for example, port 80 which is a default port of the HTTP protocol. Additionally, data of some special-purpose ports, which are known to occur frequently due to the operational nature of the internal network, may be removed from the training data. By removing the data of the preset general-purpose port and the preset special-purpose port from the training data, a useful clustering result can be obtained for the remaining traffic data except for data that need to be included in the firewall policy.

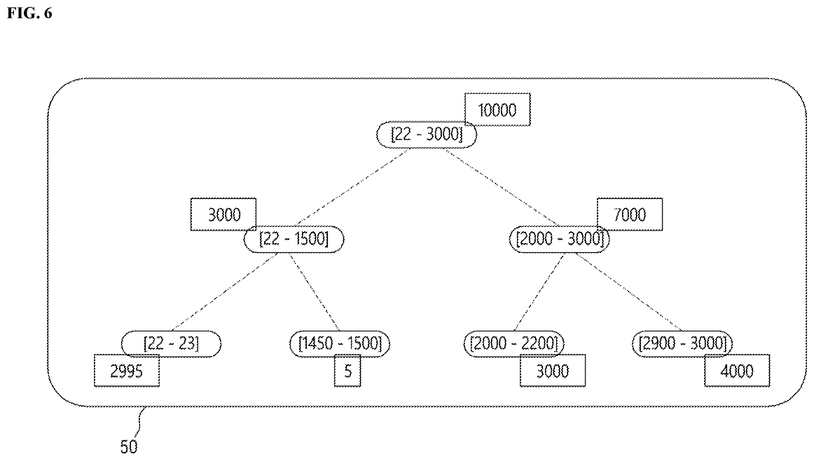

With respect to the packets included in the main cluster, the firewall policy optimizing method composes a rule consisting of the destination IPs and destination ports of the respective packets and adds the configured rule to a rule set 60 as shown in FIG. 7. In this case, those that added to the rule set 60 may include a first type of rules corresponding to the preset general-purpose port, a second type of rules corresponding to the preset special-purpose port, a third type corresponding to the main cluster obtained as a result of performing the clustering, and the fourth type of rules corresponding to an outlier record.

In the training data, upon identifying the remaining record excluding records previously reflected in the first type rule, the second type rule, or the third type rule and identifying an outlier record by using the statistical data in the remaining record, the firewall policy optimizing method may compose the fourth type of rules corresponding to the outlier record. The outlier record may indicate data corresponding to an outlier, for example, in the number of packet occurrences or packet size.

For the second clustering, the firewall policy optimizing method may utilize a well-known clustering method such as hierarchical clustering, Gaussian mixture, or K-Means clustering. The second clustering may result in the formation of a plurality of clusters, of which one or more main clusters may be selected for exceeding a reference value. The main cluster may be selected, for example, depending on whether the total number of packets included in the cluster exceeds a second reference value. As described above, since the second clustering is for discovering clusters missing from the first clustering, it may be necessary to slightly relax the selection criteria. Accordingly, the second reference value may be smaller than the first reference value.

In some embodiments, dimension reduction may be performed in the second clustering process. As described above, since the second clustering performs clustering by using many field values to take into account more information, it may increase the dimension inefficiently. This degrades clustering performance, which may be prevented through dimension reduction by applying a well-known dimensionality reduction method such as principal component analysis, whereby clustering may be performed on a reduced-dimensional feature space as a result of the dimensionality reduction. A rule corresponding to the main cluster obtained as a result of the clustering as above may be further added to the rule set.

Next, in Step S140, candidate unit policies are generated by using the rule set. As described above, the rule set is information configured including destination IPs and destination ports. Additionally, the candidate unit policies may be information configured including source IPs, destination IPs, and destination ports.

In this case, to generate the candidate unit policies, the firewall policy optimizing method may select, from among the records of the training data, a record having a destination IP and a destination port corresponding to a rule included in the rule set. By combining the source IP of the selected record with the destination IP and destination port of the rule, each candidate unit policy is generated.

Meanwhile, the records of the training data may maintain residual records that are not selected in the above-described manner. With respect to the remaining records, candidate unit policies may be generated, including ports in a predetermined range in addition to the source IPs and destination IPs of the remaining records. The ports in the predetermined range may be understood as being in an arbitrary port range designated by the administrator to meet the network management policy of the internal network. The predetermined range may be determined in consideration of the applied service of the remaining record. Exceptionally, when the applied service of the remaining record is unknown, the predetermined range may be designated as ‘any’.

Then, in Step S150, the firewall policy optimizing method calculates a coverage score for the degree to which the candidate unit policies generated in the above-described manner cover the firewall policies of the existing policy set. Since the traffic log is a log (i.e., log records) of network traffic that has passed through the firewall according to the firewall policies of the existing policy set, the coverage score may be calculated by counting the number of missing (or dropped) records denied by all of the unit firewall policies (e.g., candidate unit policies) included in the candidate policy pool in the traffic log. Therefore, the coverage score may be calculated to decrease as the number of missing (or dropped) records increases.

When the coverage score exceeds the reference value (S160), the firewall policy optimizing method further generates candidate unit policies (S140) or modifies an existing candidate unit policy. This action will be repeated until the coverage score falls below the reference value.

In the traffic log, the missing (or dropped) record rejected (denied) by all of the unit firewall policies included in the candidate policy pool may occur by setting the predetermined range of the ports too narrow at the time of generation of candidate unit policies composed of ports in the predetermined range in addition to the source IPs and destination IPs of the remaining records. Accordingly, the candidate unit policies can be modified to widen the range of ports.

In some embodiments, when the coverage score exceeds the reference value (S160), the firewall policy optimizing method may continue to proceed from the clustering of the training data (S120). In this case, to ensure there is no missing cluster, the criterion for selecting the main cluster may be eased, or the criterion attribute for selecting the main cluster may be changed.

When the coverage score falls short of the reference value (S160), the candidate unit policies are merged in Step S170, resulting in the generation of an optimized firewall policy. The respective candidate unit policies are those generated, if the traffic log contains a record matching the destination IP and destination port of the rule included in the rule set, by combining the source IP of the record with the destination IP and destination port of the rule. Therefore, the respective candidate unit policies are destined to be fragmented. This may be taken into consideration to minimize the number of firewall policies by grouping and merging source IPs, destination IPs, or destination ports.

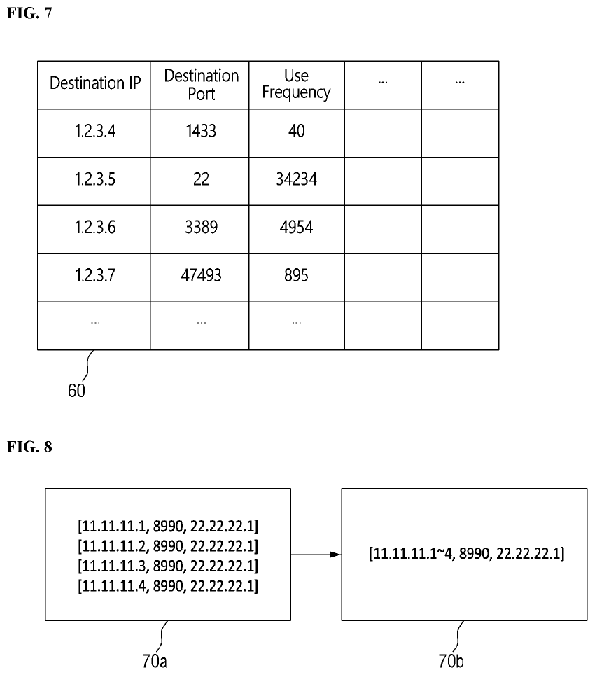

FIG. 8 shows illustrative candidate unit policies before merging at 70a and after merging at 70b. There are a total of four candidate unit policies before the merger. Additionally, the four candidate unit policies have the same destination IP and destination port except for the source IPs. Additionally, between the source IPs, the last addresses are immediately adjacent to each other. Accordingly, as shown in FIG. 8, by changing the source IPs to an IP range ‘11.11.11.1 to 4’, four candidate unit policies can be optimized into one firewall policy.

The merging may be performed by an identical-IP discovery method and a maximum IP-port-first discovery method.

According to the identical-IP discovery method, candidate unit policies using the same source IP and the same source port or using the same destination IP and the same port are merged into one, and candidate unit policies using the same source IP and the same destination IP are merged based on the port number. Additionally, candidate unit policies having consecutive IPs may be merged to have IPs grouped in the form of subnets.

According to the maximum IP-port-first discovery method, a predetermined data structure is generated based on the number of references of the candidate unit policy, and candidate unit policies are regenerated based on the IP or port of data with a large number of references, causing the respective candidate unit policies to have consecutive IPs, thereby allowing the candidate unit policies having consecutive IPs to be merged to have IPs grouped in the form of subnets.

In some embodiments, after the merging of the candidate unit policies (S170), the firewall policy optimizing method may re-compute the coverage score for the merged firewall policy, and it may re-verify whether the re-computed coverage score exceeds the reference value. As described, the firewall policy optimization process according to the present embodiment can completely replace the existing firewall policy by performing verification and re-verification of the optimized firewall policy.

Next, the optimized firewall policy may be applied to the firewall system through the confirmation of the administrator's user equipment (S180).

The technical idea of the present disclosure described with reference to FIGS. 1 to 8 so far may be implemented as computer-readable codes on a computer-readable medium. The computer-readable recording medium may be, for example, a removable recording medium (USB storage device or removable hard disk). The computer program recorded in the computer-readable recording medium may be transmitted to and installed in other computing devices through a network such as the Internet so that the computer program can be used by the other computing devices.

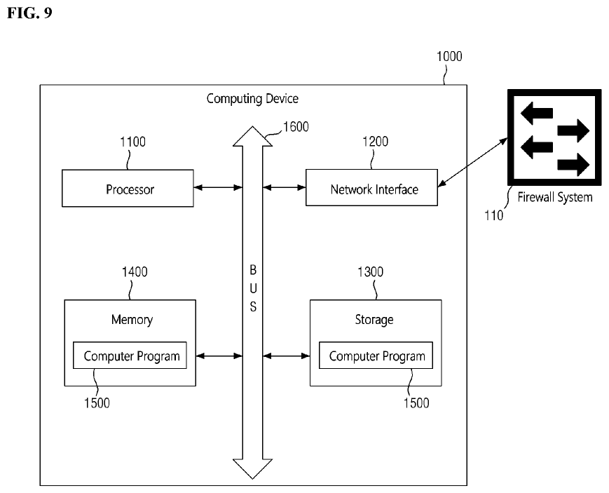

The following describes a hardware configuration of an exemplary computing device according to some embodiments of the present disclosure with reference to FIG. 9. The computing device may be, for example, the firewall policy optimizing apparatus 100 described with reference to FIG. 1.

FIG. 9 is a diagram of a hardware configuration that may implement a computing device in various embodiments of the present disclosure. The computing device 1000 according to the present embodiment may include a processor 1100, a system bus 1600, a network interface 1200, a memory 1400 for loading a computer program 1500 executed by the processor 1100, and a storage 1300 for storing the computer program 1500. FIG. 9 exclusively shows the components related to some embodiments of the present disclosure. Accordingly, those skilled in the art to which the present disclosure pertains can know that other general-purpose components than those shown in FIG. 9 may be further included.

The computing device 1000 may be the firewall policy optimizing apparatus 100 described with reference to FIG. 1. At this time, as shown in FIG. 9, the network interface 1200 may be connected to the firewall system 110, whereby the computing device 1000 receives a traffic log from the firewall system 110 and transmit, along with information on the optimized firewall policy for the firewall system 110, a control signal indicating to update the firewall policy being employed into the optimized firewall policy.

In some embodiments, the very computing device 1000 may be the firewall system. Then, the computing device 1000 becomes a device that autonomously and automatically generates an optimized firewall policy while performing the function of the firewall system. The optimized firewall policy may replace the existing firewall policy under the confirmation of the administrator.

The computing device 1000 may be connected to the user equipment through the network interface 1200. The computing device 1000 may send the user equipment the information related to firewall policy optimization and may receive, from the user equipment, a control signal related to firewall policy optimization.

The processor 1100 controls the overall operation of the respective components of the computing device 2000. The processor 1100 may be understood as a central processing unit (CPU). Additionally, the processor 1100 may operate on at least one software application or program for executing the methods or operations according to various embodiments of the present disclosure.

The memory 1400 stores various data, commands and/or information. The memory 1400 may load one or more programs 1500 from the storage 1300 to execute the methods or operations according to various embodiments of the present disclosure. An example of the memory 1400 may be random access memory (RAM) but is not limited thereto.

The system bus 1600 provides a communication function between the components of the computing device 1000. The system bus 1600 may be implemented as various types of buses, such as an address bus, a data bus, and a control bus. The network interface 1200 supports wired/wireless Internet communications of the computing device 1000.

The storage 1300 may non-temporarily store one or more computer programs 1500. The storage 1300 may include a non-volatile memory such as a flash memory, a hard disk, a removable disk, or any type of computer-readable recording medium well known in the art to which the present disclosure pertains.

The computer program 1500 may include one or more instructions in which the methods or operations according to various embodiments of the present disclosure are implemented. When the computer program 1500 is loaded into the memory 1400, the processor 1100 may perform the methods according to various embodiments of the present disclosure by executing one or more instructions.

The computer program 1500 may include instructions to perform operations of obtaining a traffic log of network traffic passing through a firewall subject to an existing policy set including a plurality of firewall policies, composing training data by using the traffic log, instructions to perform clustering the training data, generating a rule set composed of a plurality of rules by using a result of the clustering, generating candidate unit policies by using the rule set, calculating a coverage score for a degree to which the candidate unit policies cover firewall policies of the existing policy set, and repeating, until the coverage score satisfies a criterion, the clustering of the training data, the generating of the rule set, generating of the candidate unit policies, and the calculating of the coverage score.

In some embodiments, the computer program 1500 may merge the candidate unit policies and thereby further include instructions to construct an optimized firewall policy set composed of the plurality of firewall policies, and instructions to activate the optimized firewall policy set in the firewall system.

While a few exemplary embodiments of the present disclosure have been described with reference to the accompanying drawings, those skilled in the art will readily appreciate that various changes in form and details may be made therein without departing from the technical idea and scope of the present disclosure as defined by the following claims. Therefore, it is to be understood that the foregoing is illustrative of the present disclosure in all respects and is not to be construed as limited to the specific exemplary embodiments disclosed.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as intemet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

1. A method performed by a computing device for optimizing firewall policies, the method comprising:
obtaining a traffic log of network traffic passing through a firewall subject to a policy set comprising a plurality of firewall policies;
generating training data by using the traffic log;
clustering the training data;
generating a rule set comprising a plurality of rules by using a result of the clustering;
generating candidate unit policies by using the rule set;
calculating a coverage score indicating a degree to which the candidate unit policies cover firewall policies of the policy set; and
repeating the generating of the candidate unit policies and the calculating of the coverage score until the coverage score satisfies a criterion.

2. The method of claim 1, wherein the generating of the training data comprises:
generating statistical data for at least one item in the traffic log; and
generating the training data comprising original data of the at least one item in the traffic log and the generated statistical data.

3. The method of claim 2, wherein the clustering of the training data comprises:
performing a first clustering by using the at least one item in the traffic log among the training data; and
performing a second clustering by using at least one of the statistical data among the training data.

4. The method of claim 3, wherein the first clustering is clustering based on a destination port number, and
wherein the performing of the first clustering comprises:
generating data for clustering, among the training data with data excluded out of a preset general-purpose port number and a preset special-purpose port number; and
performing clustering by using the data for clustering.

5. The method of claim 4, wherein the generating of the rule set comprises:
adding, to the rule set, a first type rule corresponding to the preset general-purpose port number;
adding, to the rule set, a second type rule corresponding to the preset special-purpose port number;
adding, to the rule set, a third type rule corresponding to a main cluster obtained as a result of the performing of the clustering by using the data for clustering;
identifying, in the training data, remaining records excluding records that have been reflected in the first type rule, the second type rule, or the third type rule;
identifying, in the remaining records, an outlier record using the statistical data; and
adding, to the rule set, a fourth type rule corresponding to the outlier record.

6. The method of claim 3, wherein the performing of the second clustering comprises:
reducing a dimension of data for clustering;
performing clustering on a reduced-dimensional feature space as a result of the reducing of the dimension; and
adding, to the rule set, a fifth type rule corresponding to a main cluster obtained as a result of the performing of the clustering.

7. The method of claim 1, wherein the calculating of the coverage score comprises:
identifying, in the traffic log, the missing records that are denied by all of the candidate unit policies; and
calculating the coverage score based on a number of the missing records.

8. The method of claim 1, wherein the rule set is information configured by including a destination IP address and a destination port number,
wherein the candidate unit policies are information configured by including a source IP address, a destination IP address, and a destination port number, and
wherein the generating of the candidate unit policies comprises:
selecting, from among records of the training data, a record having a destination IP address and a destination port number corresponding to a rule included in the rule set; and
generating a first candidate unit policy by combining a source IP address of the selected record with the destination IP address and destination port number of the rule.

9. The method of claim 8, wherein the generating of the candidate unit policies comprises:
further generating a second candidate unit policy comprising a source IP address, a destination IP address, and a port number range of a predetermined range corresponding to other remaining records except for the selected record among the records of the training data.

10. The method of claim 9, wherein the repeating of the generating of the candidate unit policies and the calculating of the coverage score comprises:
based on the coverage score being less than a reference value, adjusting the second candidate unit policy to broaden the port number range of the second candidate unit policy.

11. The method of claim 1, wherein the obtaining of the traffic log comprises:
calculating a frequency distribution for each destination port number range with respect to the traffic log, and
wherein the frequency distribution when satisfying a predetermined condition exclusively allows the generating of the training data, the clustering of the training data, the generating of the rule set, the generating of the candidate unit policies, the calculating of the coverage score, and the repeating of the generating of the candidate unit policies and the calculating of the coverage score to proceed.

12. The method of claim 11, wherein the calculating of the frequency distribution for each destination port number range with respect to the traffic log comprises:
generating an interval tree based on a destination port number of the traffic log; and
determining whether there is a node whose frequency is equal to or less than a reference among nodes of the interval tree.

13. An apparatus for optimizing firewall policies, comprising:
a network interface connected to a firewall system;
memory; and
a processor for executing a firewall policy optimization program loaded into the memory,
wherein the firewall policy optimization program comprises instructions to perform operations of:
obtaining a traffic log of network traffic passing through a firewall subject to a policy set comprising a plurality of firewall policies;
generating training data by using the traffic log;
clustering the training data;
generating a rule set comprising a plurality of rules by using a result of the clustering;
generating candidate unit policies by using the rule set;
calculating a coverage score indicating a degree to which the candidate unit policies cover firewall policies of the policy set; and
repeating, until the coverage score satisfies a criterion, the clustering of the training data, the generating of the rule set, the generating of the candidate unit policies, and the calculating of the coverage score.

14. The apparatus of claim 13, wherein the generating of the training data comprises:
generating statistical data for at least one item in the traffic log; and
generating training data comprising original data of at least one item in the traffic log and the generated statistical data.

15. The apparatus of claim 13, wherein the calculating of the coverage score comprises:
identifying, in the traffic log, the missing records that are denied by all of the candidate unit policies; and
calculating the coverage score based a number of the missing records.

16. The apparatus of claim 13, wherein the rule set is information configured by including a destination IP address and a destination port number,
wherein the candidate unit policies are information configured by including a source IP address, a destination IP address, and a destination port number, and
wherein the generating of the candidate unit policies comprises:
selecting, from among records of the training data, a record having a destination IP address and a destination port number corresponding to a rule included in the rule set; and
generating a first candidate unit policy by combining a source IP address of the selected record with the destination IP address and destination port number of the rule.

17. The apparatus of claim 13, wherein the obtaining of the traffic log comprises:
calculating a frequency distribution for each destination port number range with respect to the traffic log, and
wherein the frequency distribution when satisfying a predetermined condition exclusively allows execution of the generating of the training data, the clustering of the training data, the instructions to perform the generating of the rule set, the generating of the candidate unit policies, the calculating of the coverage score, and the repeating the generating of the candidate unit policies and the calculating of the coverage score.

18. A computer-readable medium storing a computer program including computer-executable instructions for causing, when executed in a computing device, the computing device to perform operations including:
obtaining a traffic log of network traffic passing through a firewall subject to a policy set comprising a plurality of firewall policies;
generating training data by using the traffic log;
clustering the training data;
generating a rule set comprising a plurality of rules by using a result of the clustering;
generating candidate unit policies by using the rule set;
calculating a coverage score indicating a degree to which the candidate unit policies cover firewall policies of the policy set; and
repeating the generating of the candidate unit policies and the calculating of the coverage score until the coverage score satisfies a criterion.
